(19) United States
(12) Patent Application Publication
(10) Pub. No.: US 2011/0082502 A1
(43) Pub. Date: Apr. 7, 2011

(54) Apparatus for Pacifying an Infant

(76) Inventor: Kristie Lynn Gates, Massillon, OH (US)

(21) Appl. No.: 12/966,009

(22) Filed: Dec. 13, 2010

Related U.S. Application Data
(63) Continuation-in-part of application No. 12/380,692, filed on Mar. 2, 2009.

(51) Int. Cl. A61J 17/00

(52) U.S. Cl. 606/236

(57) ABSTRACT

Some embodiments of an infant pacifying device can comprise a nipple strapped to an adult finger, wherein the nipple is pivotally mounted to a finger strap. Thus, the adult's finger can move relative to the infant without pulling the pacifier from the infant's mouth. In some embodiments, the nipple is joined to the finger strap through a ball-and-socket or a universal joint.

### CROSS REFERENCE TO RELATED APPLICATIONS

This application is a continuation-in-part of U.S. patent application Ser. No. 12/380,692 filed Mar. 2, 2009 and now pending, which is incorporated herein by reference in its entirety.

### I. BACKGROUND OF THE INVENTION

A. Field of Invention

Embodiments of this invention relate to devices for pacifying and/or occupying a human infant.

B. Description of the Related Art

The use of pacifiers is well known as a means of quieting, entertaining or otherwise occupying the attention of a human infant. A typical pacifier includes a handle for applying the pacifier to the infant; however, usually the device is principally held by the sucking action of the infant. Thus, it is common to have the pacifier fall from the infant's mouth. This is problematic for several reasons. Namely, having lost the benefit of the pacifier, the infant is likely cry, and the pacifier may become difficult or impossible to retrieve. Additionally, the pacifier is likely to contact a floor or other unsanitary surface or object, thus potentially causing sickness.

A variety of devices have been developed for preventing loss of the pacifier by the infant; however, each has certain limitations. Some such prior devices strap the pacifier to the infant's hand or wrist. This still leaves the pacifier under the infant's control, and is likely to result in it contacting unsanitary surfaces. Furthermore, since it is attached to the infant, it may be awkward for a care giver to place the pacifier in the infant's mouth. In other devices the pacifier is strapped to the infant's face thus creating potential airway obstruction. Further, such a device is likely to be objectionable to care givers inasmuch as it essentially functions as a muzzle.

What is needed is a pacifier that can be kept under the control of a care giver while remaining convenient to use, easy to locate quickly, and sanitary. The present invention provides devices and methods for overcoming some shortcomings of the prior art

### II. SUMMARY OF THE INVENTION

Some embodiments relate to a An infant pacifying device, comprising: a finger engagement member adapted to receive a human adult finger in a generally fixed relation; a pacifier mounting member having a first end and a second end, the first end including a means for securing the pacifier mounting member to the finger engagement member in a retaining relation, the second end extending in a generally perpendicular direction relative to a face of the finger engagement member and the second end including a pivotable mounting member for receiving a pacifier in a pivotal relation; and a pacifying member comprising a nipple member having a pivotable engaging member at one end adapted to receive the pivotable mounting member in a pivotal relation, the pacifying member further comprising a guard flange member disposed between the nipple member and the pivotable engaging member in a fixed relation.

According to some embodiments the finger engagement member comprises: a generally rectangular fabric member having a first end and an opposing second end, and having a first face and an opposing second face, the first and second faces defining a through-hole in a generally central location; a plurality of hook fasteners disposed on the first face of the fabric member near the first end; and a plurality of loop fasteners disposed on the second face of the fabric member near the second end.

According to some embodiments the means for securing the pacifier mounting member to the finger engagement member comprises a button portion which is proportioned to engage the through-hole in a retaining relation.

According to some embodiments the pivotable mounting member and the button portion are separated by a shaft member.

According to some embodiments the pivotable mounting member comprises either the ball or socket portion of a ball-and-socket joint.

According to some embodiments the socket defines either a hemispherical socket or a semi-hemispherical socket.

According to some embodiments the pivotable mounting member comprises a ball portion of a ball-and-socket joint, and wherein the pivotable engaging member comprises a socket for receiving the pivotable mounting member.

According to some embodiments the pivotable engaging member comprises either the ball or socket portion of a ball-and-socket joint.

According to some embodiments the socket defines either a hemispherical socket or a semi-hemispherical socket.

According to some embodiments the pivotable engaging member comprises the socket portion of a ball-and-socket joint, and wherein the pivotable mounting member comprises a ball portion for receiving the pivotable engaging member.

According to some embodiments the pacifying member further comprises a base member having a first end fixedly attached to the guard flange member and a second end defining a recess comprising a female seat adapted to receive a male end of the pivotable engaging member.

According to some embodiments the female seat engages the pivotable engaging member in a retaining relation, wherein the pivotable engaging member is free to rotate relative to the female seat about an axis of rotation.

According to some embodiments the female seat engages the pivotable engaging member in a fixed relation.

According to some embodiments an opposing end of the pivotable engaging member is free to rotate relative to the male end of the pivotable engaging member.

According to some embodiments the pivotable engaging member engages pivotable mounting member in a pivotal relation about a pivot axis.

According to some embodiments the pivot axis is perpendicular to the axis of rotation.

Some embodiments relate to an infant pacifying device, comprising: a finger engagement member comprising a generally rectangular fabric member having a first end and an opposing second end, and having a first face and an opposing second face, the first and second faces defining a through-hole in a generally central location, a plurality of hook fasteners disposed on the first face of the fabric member near the first end, and a plurality of loop fasteners disposed on the second face of the fabric member near the second end; a pacifier mounting member having a first end and a second end, the first end including a means for securing the pacifier mounting member to the finger engagement member in a retaining relation, the second end extending in a generally perpendicular direction relative to a face of the finger engagement member and the second end including a pivotable mounting member for receiving a pacifier in a pivotal relation; and a pacifying member comprising a nipple member having a pivotable engaging member at one end adapted to receive the pivotable mounting member in a pivotal relation, the pacifying member further comprising a guard flange member disposed between the nipple member and the pivotable engaging member in a fixed relation.

Some embodiments relate to an infant pacifying device, comprising: a finger engagement member adapted to receive a human adult finger in a generally fixed relation; a pacifier mounting member having a first end and a second end, the first end including a button portion for securing the pacifier mounting member to the finger engagement member in a retaining relation by way of a through hole formed in a face of the finger engagement member, and the second end of the pacifier mounting member extending in a generally perpendicular direction relative to a face of the finger engagement member, wherein the second end includes a pivotable mounting member for receiving a pacifier in a pivotal relation; and a pacifying member comprising a nipple member having a pivotable engaging member at one end adapted to receive the pivotable mounting member in a pivotal relation, the pacifying member further comprising a guard flange member disposed between the nipple member and the pivotable engaging member in a fixed relation, wherein the pacifying member further comprises a base member having a first end attached to the guard flange member and a second end attached to the pivotable engaging member.

According to some embodiments the pacifying member further comprises a base member having a first end fixedly attached to the guard flange member and a second end defining a recess comprising a female seat adapted to receive a male end of the pivotable engaging member.

According to some embodiments the female seat engages the pivotable engaging member in a retaining relation, wherein the pivotable engaging member is free to rotate relative to the female seat about an axis of rotation.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1A is a side view of an embodiment comprising a universal joint;

FIG. 1B is a side view of an embodiment comprising a ball-and-socket joint where the socket is hemispherical;

FIG. 1C is a side view of an embodiment comprising a ball-and-socket joint where the socket is a partial hemisphere;

FIG. 2 is a perspective view of a portion of an embodiment for engaging the embodiment with a finger;

FIG. 3 is a view of the device of FIG. 1A taken along line 3-3;

FIG. 4 is a view of the device of FIG. 1B taken along line 4-4; and

FIG. 5 is a view of the device of FIG. 1C taken along line 5-5.

### IV. DETAILED DESCRIPTION OF THE INVENTION

According to an embodiment an infant pacifying device can comprise a nipple strapped to an adult finger, wherein the nipple is pivotally mounted to the finger strap. Thus, the adult's finger can move relative to the infant without pulling the pacifier from the infant's mouth. In some embodiments, the nipple is joined to the finger strap through a ball-and-socket or a universal joint.

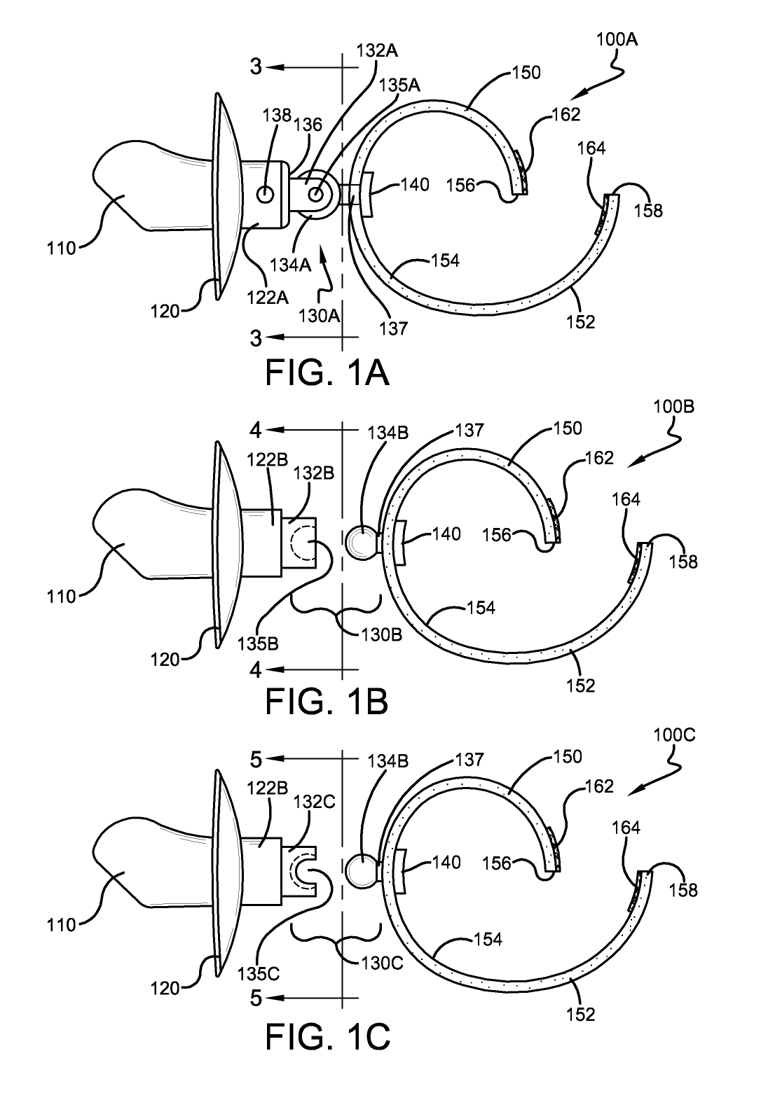

Referring now to the drawings, these are for purposes of illustrating embodiments of the invention only and not for purposes of limiting the same. FIG. 1A is a side view of an embodiment 100A, wherein an infant pacifying device includes a nipple 110 connected in a fixed relation to a base member 122A, the base member 122A including a guard flange 120 positioned between the nipple 110 and the base member 122A. The guard flange 120 functions to prevent an infant from swallowing and/or chocking on the pacifying device.

According to FIG. 1A, the base member 122A defines a generally cylindrical female seat adapted to receive a male end 136 of a pivotable engaging member 132A in either a fixed relation or a retaining relation that allows for rotation relative to the female seat. Particularly, the male end 136 is fixed to the base member 122A by one or more pins which are received by apertures 138 in the wall of the base member 122A. The one or more pins can be spring loaded, or can engage an aperture 138 of the base member 122A in a snap fit. Alternatively, a raised surface can be substituted for the one or more pins. Particularly, raised surface can extend from a side wall of the male end 136 and engage an aperture 138 in the wall of the base member 122A in a snap fit.

In some embodiments the pivotable engaging member 132A and the male end 136 can move relative to each other about a first range of motion which is circular. The pivotable engaging member 132A is joined to a pivotal mounting member 134A at an axis 135A by, for instance, a pin 170. According to FIG. 1A, the pin 170 is received by apertures 302 in a retaining relation and aperture 304 in a rotational relation wherein the pivotable mounting member 134 can rotate around the pin 170. In another embodiment the aperture 304 and the pin 170 are omitted and replaced with a raised surface on the pivotable mounting member 134A in-line with the axis 135A which engages apertures 302 in a snap fit. According to such embodiments the pivotable mounting member 134A is separable from the pivotable engaging member 132A.

According to this embodiment, the pivotable engaging member 132A and the pivotable mounting member 134A define a semicircular second range of motion that is generally perpendicular to that of the first range of motion. Thus, taken together, the parts 132A, 134A having circular and semi-circular ranges of motion comprise a universal joint 130A.

With further reference to FIG. 1A, the pivotable mounting member 134A includes a shaft portion 137 that terminates at an opposing end in a button portion 140. The button portion 140 is proportioned to engage a through-hole 200 in the finger engagement member 150 in a retaining relation. The pivotable mounting member 134A, shaft portion 137 and button portion 140 collectively define a pacifier mounting member.

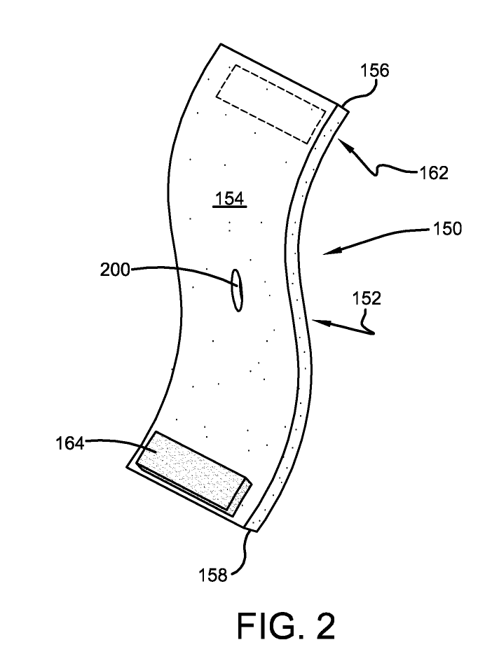

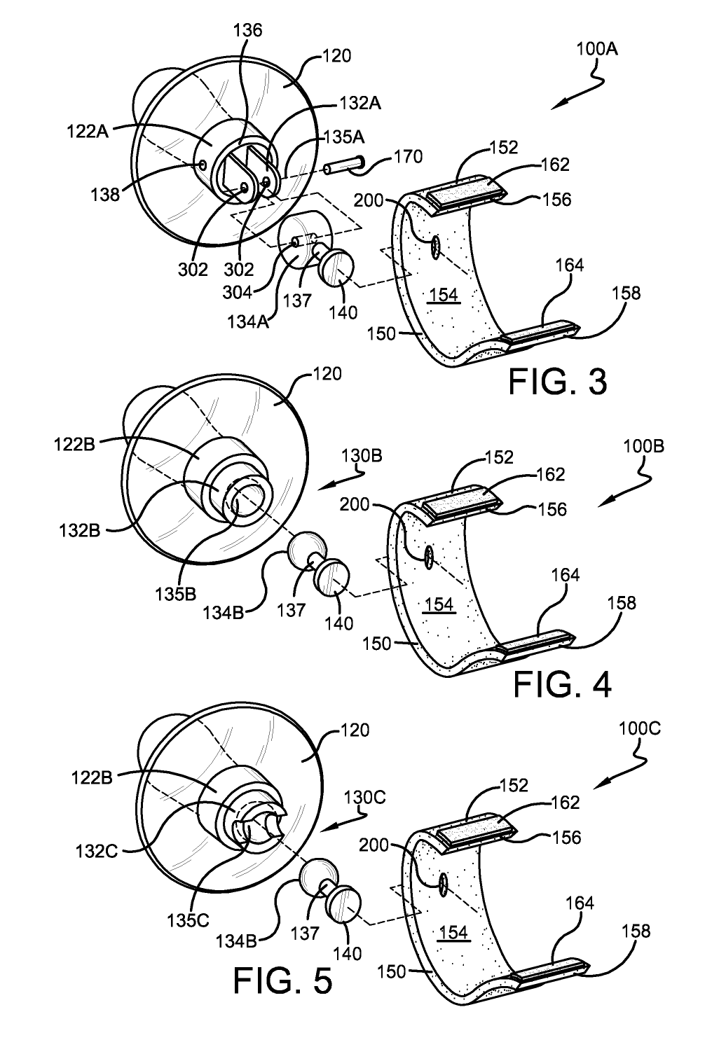

Turning to FIG. 2, with specific reference to the finger engagement member 150, when it is placed in a flattened configuration it takes on a generally rectangular shape having a first end 156 and an opposing second end 158. The finger mounting member 150 also defines a first face 152 and an opposing second face 154. The faces 152, 154 together define a through-hole 200 that is disposed in a generally central location, and which is adapted to receive the button portion 140 in a retaining relation. The finger engagement member 150 includes a patch of hook or loop fasteners 162 disposed near the first end 156 of the first face 152, and a complimentary patch of hook or loop fasteners 164 near the second end 158 of the second face 154. Thus, the ends 156, 158 can be reversibly joined to each other by hook-and-loop fasteners thereby mounting the finger engagement member 150 to a human finger. Particularly that of an adult.

The embodiment 100B shown in FIG. 1B is similar to that of FIG. 1A, but 100B comprises a ball-and-socket joint 130B rather than a universal joint 130A. According this embodiment 100B, the base member 122B can be solid rather than defining a female seat. Thus the base member 122B and the pivotable engaging member 132B can comprise a single part without relative motion between them. Further according to FIG. 1B, the pivotable engaging member 132B comprises a hemispherical socket 135B. The socket 135B is adapted to receive a ball 134B in a pivotal relation defining a semi-spherical range of motion. In some embodiments the ball and socket joint allows for detachment of the pivotable engaging member 132B and the pivotable mounting member 134B. In other embodiments, the pivotable engaging member 132B and the pivotable mounting member 134B are permanently joined. The socket 135B is shown from a rear view in FIG. 4, which clearly shows the hemispherical shape of the socket 135B. The pivotable mounting member 134B, shaft portion 137 and button portion 140 collectively define a pacifier mounting member.

The embodiment 100C shown in FIG. 1C is similar to that of FIG. 1B, but 100C comprise a ball-and-socket joint 130C wherein the socket is semi-hemispherical rather than hemispherical as in 130B. According to this embodiment 100C, the base member 122B includes a pivotable engaging member 132C comprising a semi-hemispherical socket 135C. The socket 135C is adapted to receive a ball 134B in a pivotal relation defining a semi-spherical range of motion. In some embodiments the ball and socket joint allows for detachment of the pivotable engaging member 132C and the pivotable mounting member 134C. In other embodiments, the pivotable engaging member 132C and the pivotable mounting member 134C are permanently joined. The socket 135C is shown from a rear view in FIG. 5, which clearly shows the semi-hemispherical shape of the socket 135C. The pivotable mounting member 134C, shaft portion 137 and button portion 140 collectively define a pacifier mounting member.

Having thus described the invention, it is now claimed:

1. An infant pacifying device, comprising:
a finger engagement member adapted to receive a human adult finger in a generally fixed relation;
a pacifier mounting member having a first end and a second end, the first end including a means for securing the pacifier mounting member to the finger engagement member in a retaining relation, the second end extending in a generally perpendicular direction relative to a face of the finger engagement member and the second end including a pivotable mounting member for receiving a pacifier in a pivotal relation; and
a pacifying member comprising a nipple member having a pivotable engaging member at one end adapted to receive the pivotable mounting member in a pivotal relation, the pacifying member further comprising a guard flange member disposed between the nipple member and the pivotable engaging member in a fixed relation.

2. The device of claim 1, wherein the finger engagement member comprises:
a generally rectangular fabric member having a first end and an opposing second end, and having a first face and an opposing second face, the first and second faces defining a through-hole in a generally central location;
a plurality of hook fasteners disposed on the first face of the fabric member near the first end; and
a plurality of loop fasteners disposed on the second face of the fabric member near the second end.

3. The device of claim 2, wherein the means for securing the pacifier mounting member to the finger engagement member comprises a button portion which is proportioned to engage the through-hole in a retaining relation.

4. The device of claim 3, wherein the pivotable mounting member and the button portion are separated by a shaft member.

5. The device of claim 1, wherein the pivotable mounting member comprises either the ball or socket portion of a ball-and-socket joint.

6. The device of claim 5, wherein the socket defines either a hemispherical socket or a semi-hemispherical socket.

7. The device of claim 5, wherein the pivotable mounting member comprises a ball portion of a ball-and-socket joint, and wherein the pivotable engaging member comprises a socket for receiving the pivotable mounting member.

8. The device of claim 1, wherein the pivotable engaging member comprises either the ball or socket portion of a ball-and-socket joint.

9. The device of claim 8, wherein the socket defines either a hemispherical socket or a semi-hemispherical socket.

10. The device of claim 8, wherein the pivotable engaging member comprises the socket portion of a ball-and-socket joint, and wherein the pivotable mounting member comprises a ball portion for receiving the pivotable engaging member.

11. The device of claim 1, wherein the pacifying member further comprises a base member having a first end fixedly attached to the guard flange member and a second end defining a recess comprising a female seat adapted to receive a male end of the pivotable engaging member.

12. The device of claim 11, wherein the female seat engages the pivotable engaging member in a retaining relation, wherein the pivotable engaging member is free to rotate relative to the female seat about an axis of rotation.

13. The device of claim 11, wherein the female seat engages the pivotable engaging member in a fixed relation.

14. The device of claim 13, wherein an opposing end of the pivotable engaging member is free to rotate relative to the male end of the pivotable engaging member.

15. The device of claim 12, wherein the pivotable engaging member engages pivotable mounting member in a pivotal relation about a pivot axis.

16. The device of claim 15, wherein the pivot axis is perpendicular to the axis of rotation.

17. An infant pacifying device, comprising:
a finger engagement member comprising
a generally rectangular fabric member having a first end and an opposing second end, and having a first face and an opposing second face, the first and second faces defining a through-hole in a generally central location,
a plurality of hook fasteners disposed on the first face of the fabric member near the first end, and
a plurality of loop fasteners disposed on the second face of the fabric member near the second end;
a pacifier mounting member having a first end and a second end, the first end including a means for securing the pacifier mounting member to the finger engagement member in a retaining relation, the second end extending in a generally perpendicular direction relative to a face of the finger engagement member and the second end including a pivotable mounting member for receiving a pacifier in a pivotal relation; and
a pacifying member comprising a nipple member having a pivotable engaging member at one end adapted to receive the pivotable mounting member in a pivotal relation, the pacifying member further comprising a guard flange member disposed between the nipple member and the pivotable engaging member in a fixed relation.

18. An infant pacifying device, comprising:
a finger engagement member adapted to receive a human adult finger in a generally fixed relation;
a pacifier mounting member having a first end and a second end, the first end including a button portion for securing the pacifier mounting member to the finger engagement member in a retaining relation by way of a through hole formed in a face of the finger engagement member, and the second end of the pacifier mounting member extending in a generally perpendicular direction relative to a face of the finger engagement member, wherein the second end includes a pivotable mounting member for receiving a pacifier in a pivotal relation; and
a pacifying member comprising a nipple member having a pivotable engaging member at one end adapted to receive the pivotable mounting member in a pivotal relation, the pacifying member further comprising a guard flange member disposed between the nipple member and the pivotable engaging member in a fixed relation, wherein the pacifying member further comprises a base member having a first end attached to the guard flange member and a second end attached to the pivotable engaging member.

19. The device of claim 18, wherein the pacifying member further comprises a base member having a first end fixedly attached to the guard flange member and a second end defining a recess comprising a female seat adapted to receive a male end of the pivotable engaging member.

20. The device of claim 19, wherein the female seat engages the pivotable engaging member in a retaining relation, wherein the pivotable engaging member is free to rotate relative to the female seat about an axis of rotation.
